(19) United States
(12) Patent Application Publication
(10) Pub. No.: US 2001/0054109 A1
(43) Pub. Date: Dec. 20, 2001

(54) Method for sending and receiving a data frame between at least two data processing apparatuses

(76) Inventors: Yoshitaka Sainomoto, Sagamihara (JP); Ken Watanabe, Kawasaki (JP); Tatsuya Watanuki, Ebina (JP); Toshikazu Yasue, Chigasaki (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/879,099

(22) Filed: Jun. 13, 2001

(30) Foreign Application Priority Data
Jun. 16, 2000 (JP) 2000-185917

(51) Int. Cl. G06F 15/173; G06F 15/16

(52) U.S. Cl. 709/238; 709/200

(57) ABSTRACT

In a method of distributing a frame to a line during line aggregation communications, a transmission side data processing apparatus selects a line to which a frame is transmitted, so that the transmission data amounts of respective lines become uniform. Order information is inserted into the transmission frame and the frame is transmitted to the selected line. A reception side data processing apparatus sequentially executes a reception process for a received frame, in accordance with the order information derived from each received frame.

### BACKGROUND OF THE INVENTION

The present invention relates to techniques of aggregating a plurality of communication lines (hereinafter simply called lines) interconnecting systems as one virtual logical line.

It is assumed herein that two systems are interconnected by a plurality of lines for communications.

A plurality of lines are aggregated to consider them as one virtual logical line. A data train is not transmitted from one line but the data train is distributed to a plurality of lines in the unit of a communication frame, for data transmission. A reception side system collects communication frames (hereinafter simply called frames) from the lines and reconfigures the original data train. Such communication techniques are collectively called line aggregation communication techniques.

With the line aggregation communication techniques, it is important for a transmission side system to select a method of distributing frames to a plurality of lines, for data transmission. The following two methods are generally used. One is a method of distributing frames by their types and the other is a round robin method. With the former method, frames to be transmitted from the same application program, frames to the transmitted to the same destination host, or frames to be transmitted from the same source host, are considered as the same type and transmitted from the same line. With the latter method, the numbers of packets are uniformly distributed to all lines.

### SUMMARY OF THE INVENTION

In line aggregation communications, each system aggregates for data communications a plurality of lines, which are otherwise controlled independently, as one logical line. During communications, therefore, the order of frames before distribution at a transmission side system becomes different from the order of frames after collection at a reception side system. In order to avoid communication errors to be caused by different frame orders between the transmission side and reception side systems, it is necessary to provide a mechanism for guaranteeing the frame order at both the transmission side and reception side systems.

According to the above-described method of distributing frames by their types, frames sent to different lines have no data relevance. Therefore, even if the orders of frames flowing on different lines are exchanged, communications are not influenced. With this distribution method, if frames are distributed to each line by using line selection information derived from frame address information and application information, the number of frames flowing on each line is statistically dispersed so that a load of each line can be dispersed with good balance and the communication bandwidth is expected to be improved. However, if this distribution method is applied to the communications that all frames have the same address information and application information, such as two systems connected in one-to-one, the line selectable for frame transmission is always fixed so that frames are concentrated on a particular line and the communication bandwidth of all lines cannot be used. Namely, according to this distribution method, although the frame order can be guaranteed, the communication bandwidth of all lines under aggregation cannot be used efficiently.

With the round robin distribution method, the numbers of frames transmitted to all lines become uniform so that the lines can be used more efficiently than the distribution method by frame types. However, the frame order cannot be guaranteed so that recovering the order of transmission frames is required to rely upon a higher level communication protocol.

It is an object of the present invention to improve a line use efficiency of line aggregation communications more than the round robin distribution method, to use the communication bandwidth efficiently and to guarantee the frame order.

Each of a transmission side system and a reception side system has a CPU (Central Processing Unit), a storage unit and a LAN (Local Area Network) controller. CPU executes an application program to generate data to be transmitted from the transmission side system to the reception side system and stores the data in the storage unit.

The LAN controller has line control units 1 to N, a protocol processing unit and a line aggregation communication control unit. The line control units 1 to N are connected to lines 1 to N.

The protocol processing unit is a unit for realizing the functions from the presentation layer to the network layer of the OSI (Open System Interconnection) fundamental model, and in addition for realizing a portion of the function of the data link layer. For example, in a network of a CSMA/CD (Carrier Sense Multiple Access with Collision Detection) type stipulated by IEEE (The Institute of Electrical and Electronics Engineers) 802.3, the functions up to the function of adding a MAC (Media Access Control) address to transmission data is realized.

The line control units 1 to N provide a function of controlling the corresponding lines 1 to N and transmitting/receiving a frame to/from each line. The line aggregation communication control unit is provided between the line control units and protocol processing unit for realizing the line aggregation communications, and has a transmission control unit, a reception control unit and a line aggregation communication protocol processing unit. The line aggregation communication protocol is a protocol to be used for exchanging various information on the line aggregation communications between two or more systems interconnected to realize the line aggregation communications. The line aggregation communication protocol processing unit performs various status management processes, a line management process, and an information exchange process by using the line aggregation communication protocol, respectively for the line aggregation communications. The line aggregation communication protocol processing unit detects a change in lines constituting a logical line, and notifies line subscription and secession to the transmission and reception control units.

The transmission control unit has a line selection control unit, an order information insertion control unit and a transmission line determining unit, whereas the reception control unit has a reception order control unit and an order information deletion unit.

During a transmission process, the protocol processing unit converts the format of data generated by the application program into a frame format capable of being transmitted to the network. Thereafter, the protocol processing unit outputs the frame to the transmission line determining unit. The transmission line determining unit derives the frame length of the frame. The line selection control unit selects a line. The line selection control unit stores a cumulative amount of data transmitted to each of a plurality of aggregated lines, and selects the line having the smallest cumulative amount when the frame is output. Next, the order information insertion control unit inserts order information into the frame. For example, the order information is a sequence number which corresponds to the number of transmitted frames or a data amount type sequence number which is obtained by counting transmitted data in the unit of byte. After these processes, the transmission line determining unit outputs the frame to the line control unit which controls the selected line. The line control unit transmits the frame to the line.

During a reception process, upon reception of a frame from a line, the line control unit 1 to N notifies a frame reception to the reception order control unit of the reception control unit. The reception order control unit does not process immediately the received frame, but suspends once the reception process. The reception order control units stores the order information of the preceding frame, such as the frame sequence number and a data amount type sequence number. This order information is compared with the order information contained in the frame whose reception process was suspended. Sequentially starting from the frame having the coincident order information, the order information deletion unit deletes the order information contained in the frame. Thereafter, the frame is output to the protocol processing unit to execute the reception process.

### BRIEF DESCRIPTION OF THE DRAWINGS

FIG. 1 is a diagram showing an example of the structure of a data communication system according to an embodiment.

FIG. 2 is a diagram showing an example of the structure of a line table.

FIG. 3 is a diagram showing an example of the structure of a reception processing table.

FIG. 4 is a diagram showing an example of an order information insertion form for IEEE 802.4 type frames.

FIG. 5 is a flow chart illustrating a transmission procedure.

FIG. 6 is a flow chart illustrating a reception procedure.

FIG. 7 is a flow chart illustrating a line addition procedure.

FIG. 8 is a flow chart illustrating a line deletion procedure.

FIG. 9 is a diagram showing an example of an order information insertion form for Ethernet frames.

FIG. 10 is a diagram showing another example of the data communication system.

FIG. 11 is a flow chart illustrating a transmission procedure of the data communication system shown in FIG. 10.

FIG. 12 is a flow chart illustrating a reception procedure of the data communication system shown in FIG. 10.

FIG. 13 is a diagram showing another example of the data communication system.

FIG. 14 is a flow chart illustrating a transmission procedure of the data communication system shown in FIG. 11.

FIG. 15 is a flow chart illustrating a reception procedure of the data communication system shown in FIG. 11.

### DETAILED DESCRIPTION OF THE EMBODIMENTS

Embodiments of the invention will be described.

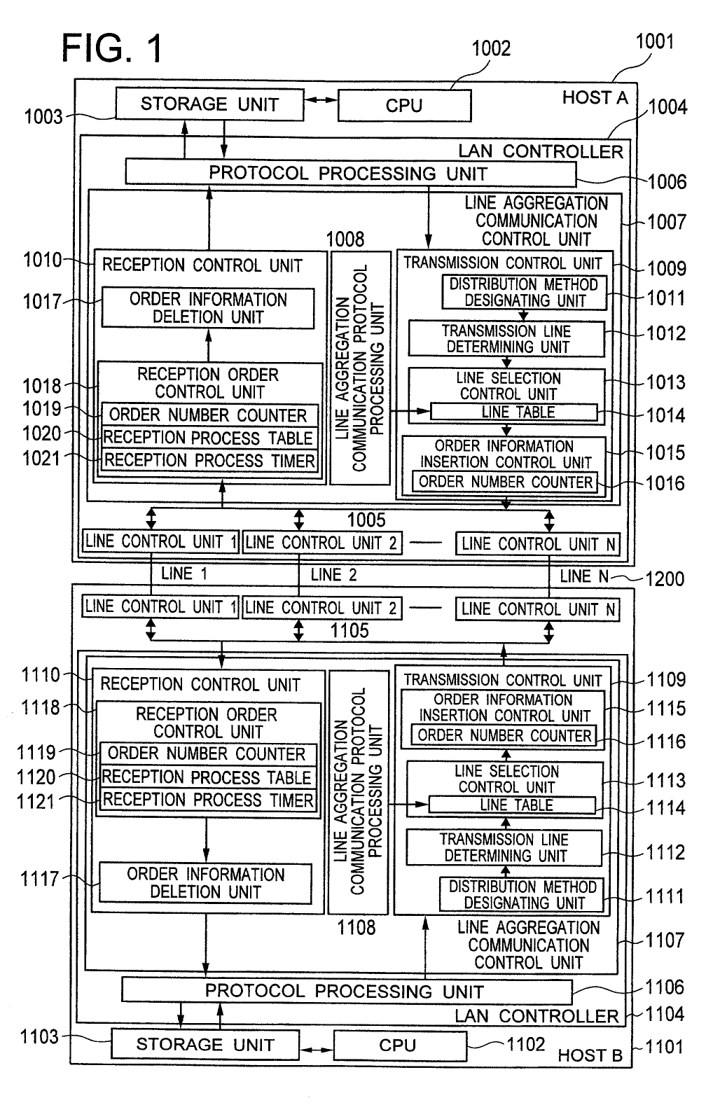

FIG. 1 is a block diagram showing the structure of a data communication system according to an embodiment.

A host A 1001 and a host B 1101 are interconnected by a plurality of lines 1 to N 1200. By using these lines, both the hosts communicate with each other. Each of the hosts A 1001 and B 1101 distributes communication frames to the lines 1 to N 1200 for transmission and reception in order to use the lines as one logical line. In this embodiment, communications that a plurality of lines are aggregated as one logical line are defined as line aggregation communications. The host A 1001 and host B 1101 have the function of performing the line aggregation communications. Since the communication function of both the hosts is the same, the functional blocks will be described by taking as an example the host A 1001. The functional blocks 10xx of the host A 1001 are the same as those 11xx of the host B 1101.

The host A 1001 has a CPU 1002, a storage unit 1003 and a LAN controller 1004. In the host A, CPU 1002 executes an application program to generate data to be transmitted to the host B 1101, and the generated data is stored in the storage unit 1003.

First, the structure of the LAN controller 1004 and the function of each functional block will be described and then the frame transmission/reception procedure will be described.

The LAN controller 1004 has a protocol processing unit 1006, a line aggregation communication control unit 1007 and line control units 1 to N 1005.

The protocol processing unit 1006 executes the functions of the layers from the presentation layer to the network layer of the fundamental model of OSI (Open System Interconnection) as well as the function of a portion of the data link layer. In the case of a network of CSMA/CD (Carrier Sense Multiple Access with Collision Detection) stipulated in IEEE (The Institute of Electrical and Electronics Engineers) 802.3, the protocol processing unit 1006 executes a function of adding a MAC (Medial Access Control) address to transmission data and converting the data format used by an application program into the frame format cable of being transmitted to the network.

The line control units 1 to N 1005 control respective lines 1 to N 1200 and transmit/receive a frame to/from the line. During the reception process, the line control unit 1 to N 1005 stores received frames and outputs a reception notice to a reception control unit 1010 of the line aggregation communication control unit 1007.

The line aggregation control unit 1007 has various functions for realizing the line aggregation communication function. The line aggregation control unit 1007 has a line aggregation communication protocol processing unit 1008, a reception control unit 1009, and the reception control unit 1010. The line aggregation communication protocol processing unit 1008 manages various statuses and lines of the line aggregation communications, exchanges information with the communication destination host (in this example host B 1101) by using the line aggregation communication protocol, executes a flash process and the like. The flash process will be later described. The line aggregation communication protocol is used for exchanging various information such as a change in various management information with the communication destination host. The line aggregation communication protocol processing unit 1008 performs the above-described various processes. The line aggregation communication protocol processing unit 1008 notifies the transmission control unit 1009 and reception control unit 1010 of subscription and secession of a line to and from a line aggregation communication group which is a bundle of aggregated lines constituting one logical line. In the following, the line aggregation communication group is simply called a group.

Line subscription to the group means to increase the number of lines belonging to the group, whereas line secession from the group means to reduce the number of lines. Line subscription and secession occur when setting information of the number of lines belonging to the group is changed at the host A 1001 or host B 1101. Subscription and secession may occur in addition to a change in the setting information. For example, line aggregation communication techniques called link aggregation are known. The link aggregation provides a line aggregation communication function at the second layer of the OSI fundamental model. According to the link aggregation, upon detection of a failure of a connected line, the line is automatically seceded from the group. Conversely, upon detection of a recovery of the automatically seceded line, the line is automatically subscribed to the group.

The transmission control unit 1009 and reception control unit 1010 do not distinguish between the line subscription and secession by the setting information change and the line subscription and secession by the line failure. In either case, a simple line subscription and secession process is performed. In the case of line subscription and secession by setting information change, a flash process is performed before the subscription or secession process is performed, in accordance with a line subscription procedure or a line secession procedure to be later described. In this manner, a frame is prevented from being lost. However, in the case of automatic secession by a line failure, it is difficult to transmit a frame already stored in the buffer of the failed line. It is inevitable to lose a frame. If the frame order is to be guaranteed, the reception side host continues to wait for the lost frame, so that the reception process at the reception side host stops. In order to avoid this, a reception process timer 1121 is provided in the reception control unit 1010. As will be later described with the reception procedure, if the frame having the correct order is not received for a predetermined period, the reception side host judges that a frame was lost, and continues to perform the reception process.

In this embodiment, the line aggregation communication protocol processing unit 1008 executes all the above-described processes for the line aggregation communication. However, the details of these processes and the details of the line aggregation communication protocol are outside of the scope of the invention, and the details thereof will not be given.

The transmission control unit 1009 has a distribution method designating unit 1011, a transmission line determining unit 1012, a line selection control unit 1013 and an order information insertion control unit 1015.

The distribution method designating unit 1011 determines which one of the conventional frame distribution method for line aggregation communications and the embodiment frame distribution method is selected, and notifies the transmission line determined unit 1012 of the selected method.

The transmission line determining unit 1012 determines a frame transmission line in accordance with the distribution method designated by the distribution method designating unit 1011. The transmission line determining unit 1012 outputs the transmission frame and a frame length derived from the transmission frame to the line selection control unit 1013.

The line selection control unit 1013 outputs the frame received from the transmission line determining unit 1012 to the order information insertion control unit 1015. The order information insertion unit 1015 inserts order information into the frame received from the line selection control unit 1013. After the above processes are performed, the transmission control unit 1009 outputs the transmission frame to the line control unit 1005 which controls the line selected by the transmission line determining unit 1012. As described earlier, the transmission line determining unit 1012 has a function of executing the conventional distribution method for the line aggregation communications, and determines a line in response to an instruction from the distribution method designating unit 1011.

The order information insertion control unit 1015 has an order number counter 1016, and has a function of inserting the order number held in the order number counter 1016 into the transmission frame. The order number counter 1016 counts the number of transmitted frames. A numerical value obtained by adding 1 to the count at an optional time is the order number of a frame to be transmitted after the optional time. The process contents of inserting the order number into the transmission frame will be later described when the transmission procedure is described.

In this embodiment, the number of transmitted frames is counted and this count is used as the order number. Instead, the amount of transmitted data may be counted in the unit of byte, and the number of bytes may be used as the order number. In this case, the numerical value counted by the order number counter 1016 changes from the number of frames to the number of data bytes. Excepting this point, the function and module structure of the transmission control unit 1009 may be all the same. In the following description, unless otherwise specifically described, the number of counted frames is used as the order number. The process contents are basically the same if the number of counted bytes is used as the order number.

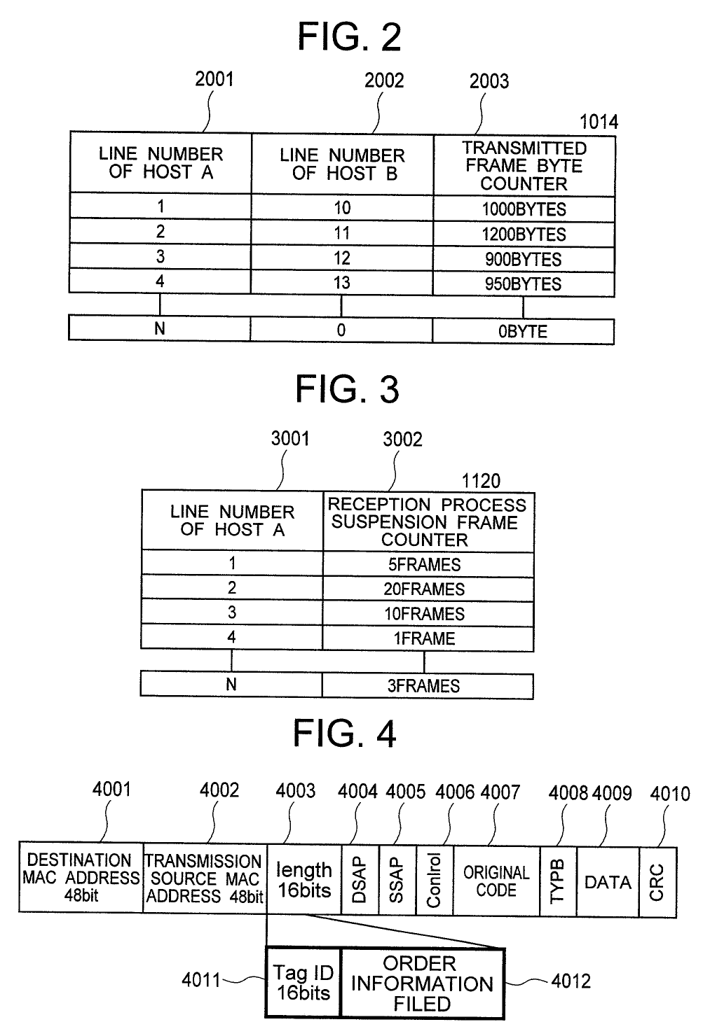

The line selection control unit 1013 has a line table 1014. An example of the structure of the line table 1014 is shown in FIG. 2. The line table 1014 stores the line number 2001 of each line belonging to the group of the host A 1001, the line number 2002 of each line of the host B 1101, and the transmitted frame byte counter 2003 for counting the cumulative value of a transmission data amount sent to each line, respectively in correspondence with each other. The transmitted frame byte counter 2003 is required to have the number of bits sufficiently larger for recording the maximum frame length capable of being sent to each line. The line table 1014 is provided for each group. Each line table 1014 has as many entries as the number of aggregated lines.

The initial value of the transmitted frame byte counter 2003 is set to 0. The line aggregation communication protocol processing unit 1008 executes a reset process when one or more transmitted frame byte counters 2003 among those transmitted frame byte counters 2003 of respective lines belonging to the group take a value equal to or smaller than a value nearest to the recordable maximum value of the transmitted frame byte counter 2003 subtracted by the number of bytes of the maximum frame length capable of being sent to the line. In practice, a threshold value satisfying this condition is preset. When any of the transmitted frame byte counter 2003 exceeds this threshold value, the line aggregation communication protocol processing unit 1008 executes the reset process. In this embodiment, the reset process is executed in the following manner. When the line aggregation communication protocol processing unit 1008 executes the reset process, the unit compares the values of the transmitted frame byte counters 2003 of all lines belonging to the group and obtains the minimum value of the transmitted frame byte counter 2003. Next, the line aggregation communication protocol processing unit 1008 subtracts the minimum value or a value smaller than the minimum value from the value of the transmitted frame byte counter 2003 of each line. The reset process is executed in the above manner so that an overflow of the transmitted frame byte counter 2003 can be prevented while the relation between the numbers of data bytes of the frames transmitted to respective lines is retained.

The line table 1014 is always managed and updated by the line aggregation communication protocol processing unit 1008 to reflect line addition or deletion information of the group. The line addition or deletion procedure will be later described.

The length of a frame to be next transmitted is input to the line selection control unit 1013 from the transmission line determining unit 1012. The line selection control unit 1013 checks the input frame length and refers to the transmitted frame byte counters 2003 in the line table 1014 to thereby determine a line to which the frame is sent. The detailed operation of the line selection control unit 1013 will be given when the transmission procedure is described.

The reception control unit 1010 has an order information deletion unit 1017 and a reception order control unit 1018.

The reception control unit 1018 has an order number counter 1019, a reception process table 1020 and a reception process timer 1021. An example of the structure of the reception process table 1020 is shown in FIG. 3. The reception process table 1020 stores the line number 3001 of a line belonging to the group of the host A 1001 and the reception process suspension frame counter 3002 for counting the number of frames received from the like, respectively in correspondence with each other. The initial value of the reception process suspension frame counter 2003 is set to 0.

The order number counter 1019 counts the number of frames subjected to the reception process. A frame having the order number equal to a numerical value obtained by adding 1 to the count of the order number counter 1019 at an optional time is judged by the reception control unit 1018 as the frame to be subjected to the reception process after the optional time.

Upon reception of a reception notice from any one of the line control units 1 to N 1005, the reception order control unit 1018 counts up the reception process suspension frame counter 3002 in the reception process table 1020 corresponding to the line which received the frame. With this count-up, the reception order control unit 1018 can have a function of holding the reception notice and suspending once the reception process without immediately executing the reception process. The reception order control unit 1018 identifies the order number of the frame to be received next, from the count of the order number counter 1019, and compares it with the order information inserted into the received frame. In this manner, the reception order control unit 1018 identifies the frame to be received next from a plurality of reception frames whose reception process are suspended. With this function, the reception order control unit 1018 can correct the order of frames received from a plurality of lines. The details of this operation will be given later when the reception procedure is described.

The order number counter 1016 of the transmission control unit 1009 counts the total number of bytes of transmitted data. If this count is used as the order number, then the order number counter 1019 of the reception control unit 1010 does not count the number of received frames but it stores the order number contained in the frame last subjected to the reception process. In this case, the criterion of judging the frame to be next subjected to the reception process becomes different. This point will be later described when the reception procedure is described.

The order information deletion unit 1017 deletes unnecessary order information from the frame whose reception order was corrected by the reception order control unit 1018. The frame from which the order information was deleted is output to the protocol processing unit 1006.

Next, the transmission/reception procedure of the line aggregation communication control unit 1007 will be described. The host A 1001 and host B 1101 have the same function and use the same transmission/reception procedure. In this embodiment, it is assumed that the host A 1001 transmits data and the host B 1101 receives the data.

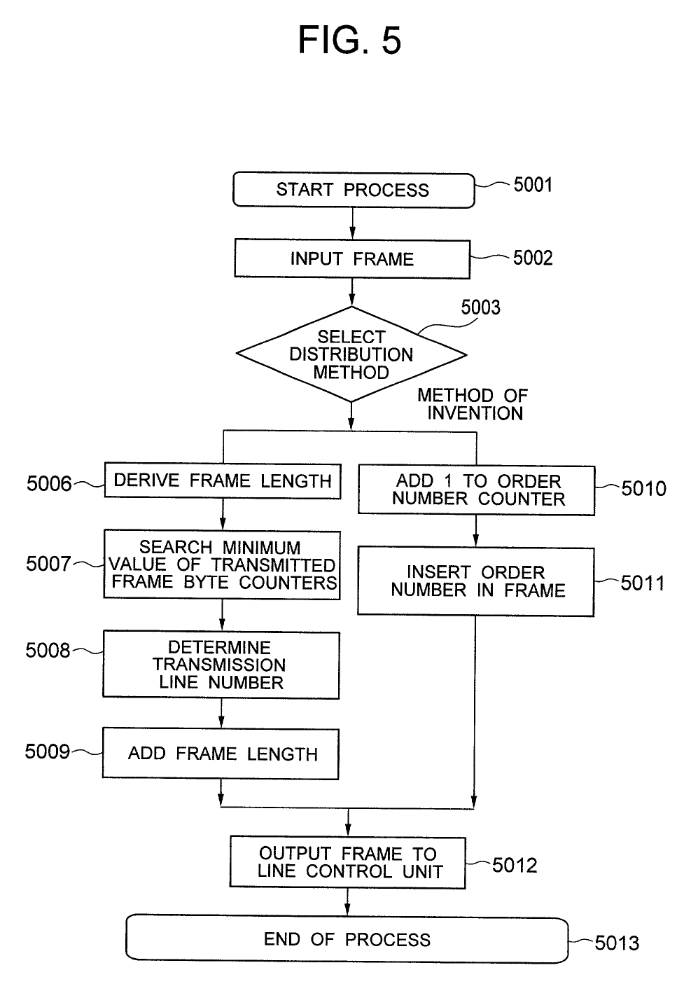

First, the transmission procedure when data is transmitted from the host A 1001 to the host B 1101 will be described with reference to FIG. 5.

First, CPU 1002 executes an application program to generate the data to be transmitted to the host B 1101, and the generated data is stored in some area of the storage unit 1003. The protocol processing unit 1006 receives the transmission data from the storage unit 1003 and converts the data format into the frame format capable of being transmitted to the network. The protocol processing unit 1006 outputs a frame to the transmission control unit 1009 of the line aggregation communication control unit 1007. The transmission control unit 1009 receives the frame supplied from the protocol processing unit 1006 (step 5002). The transmission control unit 1009 executes the following processes in order to distribute frames to a plurality of lines 1 to N 1200 managed by the transmission control unit 1009 itself and transmit the frames.

The distribution method designating unit 1011 determines which one of the embodiment frame distribution method and another different frame distribution method is to be used, and notifies the transmission line determining unit 1012 of the determined frame distribution method.

In accordance with the contents notified by the distribution method designating unit 1011, the transmission line determining unit 1012 uses the selected distribution method (step 5003) and determines the line to which the frame is distributed and transmitted. If the distribution method designating unit 1011 designates the distribution method different from the embodiment frame distribution method, the transmission line determining unit 1021 determines the lines by using the designated method. For example, this method corresponds to a distribution method of a hash type or a round robin type. With the distribution method of the hash type, a function of performing specific bit calculations is executed by using frame destination addresses and the like, and an obtained bit train is used as the line numbers to distribute frames. With the distribution method of the round robin type, frames are sequentially distributed one after another to all lines to make the numbers of frames transmitted from the lines uniform. The transmission line determining methods for these distribution methods are outside of the scope of the invention, and the description thereof is omitted.

In determining a line by the embodiment frame distribution method, the transmission line determining unit 1012 checks the length of the transmission frame and outputs the frame length to the line selection control unit 1013 (step 5006). The line selection control unit 1013 refers to the line table 1014 prepared for each group managed by the transmission line control unit 1009 itself, compares the transmitted frame byte counters 2003 to search the minimum value (step 5007), and recognizes the line number in the entry having the minimum value. The line selection control unit 1013 instructs the transmission line determining unit 1012 to transmit the frame to the line having the recognized line number. In accordance with the instruction from the line selection control unit 1013, the transmission line determining unit 1012 determines the line number of the line to which the frame is distributed (step 5008). The line selection control unit 1013 adds the frame length (the number of bytes) output from the transmission line determining unit 1012 to the transmitted frame byte counter 2003 corresponding to the recognized line number among those transmitted frame byte counters 2003 in the line table 1014 (step 5009) to thereby update the line table 1014.

Next, the order information insertion control unit 1015 inserts the order information into the transmission frame. This process may be executed in parallel with the processes of the transmission line determining unit 1012 and line selection control unit 1013 (steps 5006 to 5009), or may be executed before these processes. If the distribution method designating unit 1011 designates the distribution method different from the embodiment frame distribution method, the order information insertion control unit 1015 does not insert the order information, depending upon the type of the distribution method. For example, if the distribution method of a hash type or around robin type is used, the order information insertion control unit 1015 does not insert the order information. When the order information is inserted, the order information insertion control unit 1015 adds 1 to the count of the order number counter 1016 (step 5010) and inserts as the order number the added count in the frame (step 5011). While a frame having a longer frame length is transmitted, several frames having a shorter frame length can be transmitted. In order to recover the frame order even if one frame having the maximum line frame length flows on one line and a number of frames having the line minimum frame length flow on all other lines belonging to the group, the number of bits of the order number counter 1016 is determined in accordance with the number of lines to be aggregated, the line maximum frame length and the like minimum frame length.

If the total number of bytes of transmitted data is used as the order information, at the step 5010 the number of bytes of a frame to be transmitted is added to the count of the order number counter 1016, and at the step 5011 the added count is inserted into the frame. In this case, it is necessary that the number of bits of the order number counter 1016 is sufficiently long to the extent that the reception side can judge the order even if the count wraps around because of addition of the number of bytes of a frame to be transmitted. In this embodiment, the number of bits of the order number counter 1016 is 16 bits in both the cases that the number of frames is used as the order information and the total number of bytes of data is used as the order information.

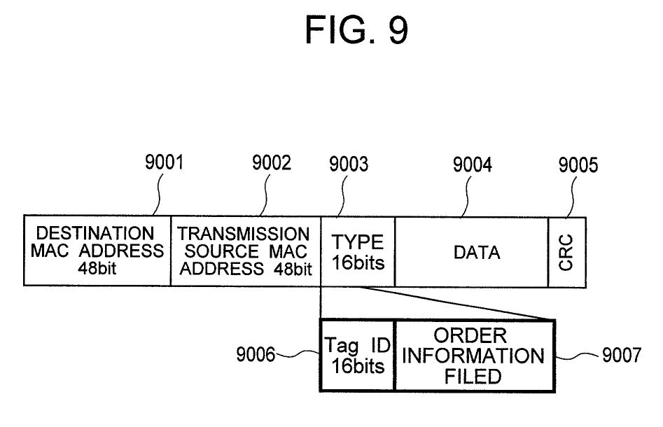

The formats used when a count is inserted as a tag in the frame will be described with reference to FIGS. 4 and 9.

An Ethernet frame (Ethernet is a registered trademark of Fuji Zerox Corporation) and a frame of the IEEE 802.3 type will be described by way of example. FIG. 9 shows the format of an Ethernet frame, and FIG. 4 shows the format of a frame of the IEEE 802.3.

As shown in FIG. 9, the frame header of the Ethernet frame has a destination MAC address field (48 bits) 9001, a transmission source MAC address field (48 bits) 9002 and a type field (48 bits) 9003, followed by an upper layer header and data. In this embodiment, order information is inserted between the transmission MAC address field 9002 and type field 9003. The order information has two fields, a tag ID field (16 bits) 9006 indicating that the order information is being inserted and an order number field (in this embodiment, 16 bits) 9007. Similar to the Ethernet frame, the header of the frame of the IEEE 802.3 type shown in FIG. 4 has a destination MAC address field (48 bits) 4001, a transmission source MAC address field (48 bits) 4002 and a frame length field (16 bits) 4003 at the same position as the type field 9003 of the Ethernet frame, followed by an upper layer header and data. Also in the frame of the IEEE 802.3, the order information having the same structure as that of the Ehernet frame is inserted between the transmission source MAC address field 4002 and a frame length field 4003. Namely, the order information constituted of a tag ID field (16 bits) 4011 and an order number field (in this embodiment, 16 bits) 4012 is inserted.

The type field 9003 of the Ethernet frame identifies the type of data to follow and is assigned a specific value for each usage. The tag ID fields 9006 and 4011 are assigned values which are different from the usage values assigned to the type field 9003 and are not essentially used as the frame length 4003. The lengths of the order information fields 9007 and 4012 may be the same 16 bits as those of the order number counter 1016 of this embodiment. For a frame inserted with a VLAN (Virtual Lan) tag defined by IEEE 802.1Q, the order information is inserted before the VLAN tag. The order information to be inserted in the embodiment is deleted at a process before a process of analyzing the VLAN tag, so that no practical problem occurs.

For frames used by a network other than the CSMA/CD type, similar functions can be realized by inserting the order information in the manner described above.

After the above-described processes are executed by the transmission control unit 1009, the transmission frame is output to the line control unit 1005 corresponding to the line 1200 having the line number determined by the transmission line determining unit 1012 (step 5012). The line control unit 1005 received the frame output from the transmission control unit 1009 sends the frame to the corresponding line 1200. If a plurality of frames are to be transmitted, the above-described transmission procedure is repeated.

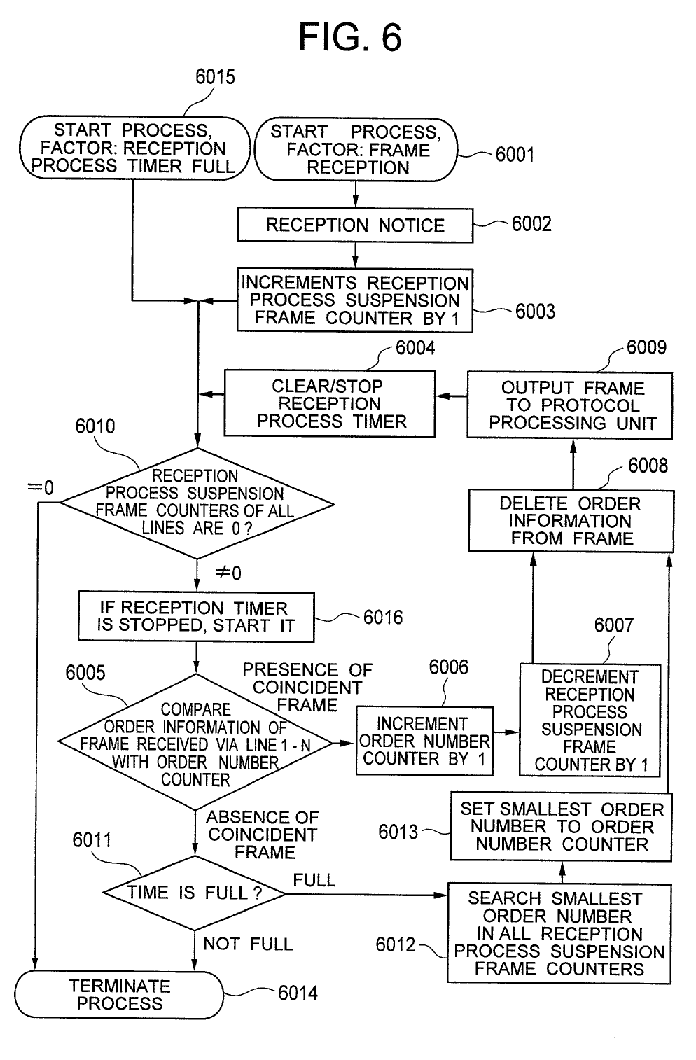

Next, the reception procedure when data transmitted from the host A 1001 is received at the host B 1101 will be described with reference to FIG. 6.

A frame transmitted from the host A 1001 is received at one of the line control units 1 to N 1105 of the host B 1101 via a corresponding one of the lines 1 to N 1200. When a frame is received, the process of the host B 1101 starts (step 6001). The line control unit 1 to N 1105 received the frame supplies a reception notice to the reception order control unit 1118 of the reception control unit 1110 (step 6002).

The reception order control unit 1118 received the reception notice does not execute immediately the reception process of the received frame, but selects a frame to be subjected to the reception process in accordance with the order information. First, in order to suspend the reception process for the received frame, of the reception process suspension frame counters 3002 in the reception process table 1120, the reception process suspension frame counter 3002 corresponding to the line number of the line from which the frame was received is incremented by 1 (step 6003). The reception order control unit 1118 refers to the reception process suspension frame counters 3002 so that presence/absence of a reception process suspension frame at each line can be confirmed.

If the reception process suspension frame counters 3002 of all the lines 1 to N are 0 (step 6010), the reception order control unit 1118 terminates the reception process (step 6014). If there is even one reception process suspension frame and the reception process timer 1121 is not operating, then the reception order control unit 1118 starts the reception process timer 1121 (step 6016). The initial value of the reception process timer 1121 is 0 and the value increases with time.

The reception order control unit 1118 refers to the reception process suspension frame counters 3002 and identifies a line having one or more reception process suspension frames among the lines 1 to N. The reception order control unit 1118 derives the order information inserted by the host A 1001 from the reception process suspension frame held in the line control unit corresponding to the identified line, and compares the derived order information with the value of the order number counter 1119 (step 6005). If there is a reception process suspension frame having the inserted order information same as the value of the order number counter 1119, the reception order control unit 1118 judges that the frame is to be next subjected to the reception process, and starts the reception process for this frame.

In the reception process, the order number counter 1119 is incremented by 1 (step 6006) and the reception process suspension frame counter 3002 in the reception process table 1120 corresponding to the line via which the frame under the reception process was received is decremented by 1 (step 6007). The frame is sent to the order information deletion unit 1117 which deletes the unnecessary order information from the frame (step 6008). The reception control unit 1110 outputs the frame with the deleted order information to the protocol processing unit 1106 (step 6009). At this time, the reception order control unit 1118 stops the reception process timer 1121 to clear the value and set the initial value (step 6004). The protocol processing unit 1106 receives the frame output from the reception control unit 1110, converts the frame format into the data format capable of being received by the application program, and passes the frame to the application program.

If at the step 6005 it is not possible to detect the reception process suspension frame having the inserted order information same as the value of the order number counter 1119, the reception order control unit 1118 checks whether the reception process timer 1112 is full (step 6011). If the reception process timer 1112 is not full, a series of processes are terminated to wait for another reception notice (step 6014).

If at the step 6011 the reception order control unit 1118 judges that the reception process timer 1112 is full, it can be judged that the frame to be next subjected to the reception process was lost. In this case, the reception order control unit 1118 does not wait for the reception of the lost frame, but starts the process for performing the reception process for the next frame. In this case, the reception order control unit 1118 starts the process asynchronously with the frame reception (step 6015).

After the steps 6010, 6016, 6005 and 6011, the reception order control unit 1118 searches the smallest order number from the order numbers inserted in all the reception process suspension frames in the lines 1 to N (step 6012). The searched smallest order number is set to the order number counter 1119 (step 6013) and the reception process is executed sequentially starting from the frame having the smallest order number.

If a frame is lost by some reason during transmission from the host A 1001 to the host B 1101 and there is a missed frame order number received at the host B 1101, then the reception process timer 1112 can be used for detecting a loss at the host B 1101 and executing the recovery process. The full time T of the reception process timer is preferably longer than at least 2L where L is a time taken to transmit data of the longest frame length capable of transmitting from the host A 1001 to the host B 1101 via the aggregated line 1200. By using the reception process timer 1112, even if a frame is lost, the reception process at the reception side host B 1101 can be prevented from being stopped because of inconsistency of the order information.

If the total number of bytes of transmitted data is used as the order information, at the step 6005 the value obtained by subtracting the number of bytes of a received frame from the value derived from the tag of the received frame is compared with the value of the order number counter 1119. At the step 6006, the value derived from the tag of the received frame is overwritten in the order number counter 1119.

With the above processes, the reception control counter 1110 rearranges the order of frames received via a plurality of lines and outputs the frames to the protocol processing unit.

Next, a line subscription and secession procedure relative to a group will be described.

As described earlier, the line aggregation communication protocol processing unit 1008 of the host A 1001 and the line aggregation communication protocol processing unit 1108 of the host B 1101 manage the status of aggregated lines. Both the hosts exchange the management information by using the line aggregation communication protocol to execute a line subscription and secession process synchronously at both the hosts. The line subscription and secession are processed in a similar manner for both the setting information change and the line failure.

For example, when line subscription or secession occurs because of setting information change, line failure or recovery at the line aggregation communication protocol processing unit 1108 of the host B 1101, the host B 1101 notifies a line change to the line aggregation communication protocol processing unit 1008 of the host A 1001 via one of the lines 1 to N 1200. Upon reception of this notice, the line aggregation communication protocol processing unit 1008 reflects the line subscription or secession upon the line table 1014.

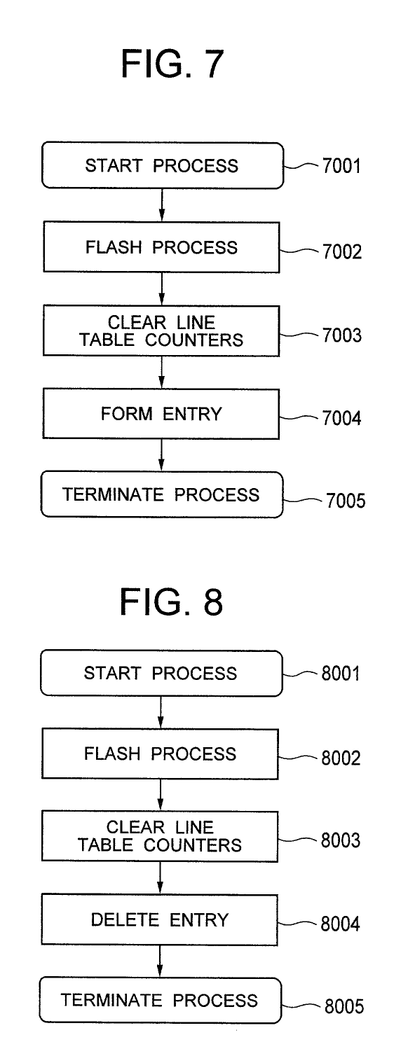

The line subscription procedure will be described with reference to FIG. 7 by taking as an example the above-described case.

Prior to the line subscription process or a line secession process, the line aggregation communication protocol processing unit 1008 first executes the flash process (step 7002). The flash process is a process of discarding once all the frames stored in transmission buffers and the like of the lines when a line is subscribed to the group or a line is seceded from the group. The flash process is executed to eliminate the irregular numbers of frames stored for a line newly subscribed to the group and other lines.

After the flash process, the line aggregation communication protocol processing unit 1008 clears the transmitted frame byte counters 2003 in all entries in the line table 1014 to 0 (step 7003). This is performed in order to prevent the frame transmission process from being concentrated upon only the newly subscribed line having a small cumulative value of transmitted data amount. The line aggregation communication protocol processing unit 1008 forms a new entry in the line table 1014 and registers the line numbers of the subscribed line at the host A 1001 and host B 1101 in this new entry (step 7004). With these processes, the line subscription procedure is completed (step 7005).

The line secession procedure will be described with reference to FIG. 8 by taking as an example the above-described case.

Similar to the line subscription procedure, the line aggregation communication protocol processing unit 1008 first executes the flash process (step 8002). When a line is seceded from the group, the flash process is executed in order not to lose a frame stored in the line. However, if the line is automatically seceded because of a line failure, it is inevitable that the frame is lost even if the flash process is executed. After the flash process, the line aggregation communication protocol processing unit 1008 clears the transmitted frame byte counters 2003 in all entries of the line table 1014 to 0 (step 8003). The line aggregation communication protocol processing unit 1008 deletes the entry of the line table 1014 in which the line numbers of the seceded line at the host A 1001 and the host B 1101 are registered (step 8004). With these processes, the line secession procedure is completed (step 8005).

The embodiment has been described by using as examples an IEEE 802.3 network and an Ethernet network. The embodiment is not limited only to these two networks. For example, the embodiment is applicable to communications using various types of lines, such as an ATM (Asynchronous Transfer Mode) network, an FDDI (Fiber Distributed Data Interface) network and a WDM (Wavelength Division Multiplexing) network. In the case of the ATM network, the embodiment is applicable at the frame level before the frame is converted to the communication data format of the ATM network, called a cell. In the case of the FDDI network, the embodiment is applicable to connection lines between a SAC (Single Attachment Concentrator) and a SAS (Single Attachment Station). In the case of the WDM network, multiplexed signals of respective wavelengths can be considered as the lines of this embodiment.

In this embodiment, in order to make the amounts of data flowing on respective aggregated lines uniform, the transmitted frame byte counter 2003 is provided for each line, and the next frame is transmitted to the line having the smallest count. In contrast, the following method is also conceivable. In place of the transmitted frame byte counter, a counter for counting the number of bytes of each frame stored in a transmission standby queue is provided for each line. In this case, similar to the above description, a line having the smallest count is selected as the line to which the next frame is transmitted. The count of this counter is updated as in the following manner. (1) As the initial value, 0 is set, and each time a line is subscribed to the group or seceded from the group, the counter is initialized. (2) When a transmission request is supplied from the protocol processing unit 1006 to the transmission control unit 1009 and when the frame is stored in the transmission standby queue of the selected line, the frame length is added to the count of the counter. (3) After the frame is sent to a line, the frame length of the transmitted frame is subtracted from the count of the corresponding counter. In this manner, the count of each counter always indicates the number of bytes of a frame stored in the transmission standby queue of each line. Since the line is selected in such a manner that. the values of counters for the lines belonging to the group are made uniform, the numbers of data bytes flowing on the respective lines can be made uniform. The tag system for ensuring the order may be quite the same as that of this embodiment.

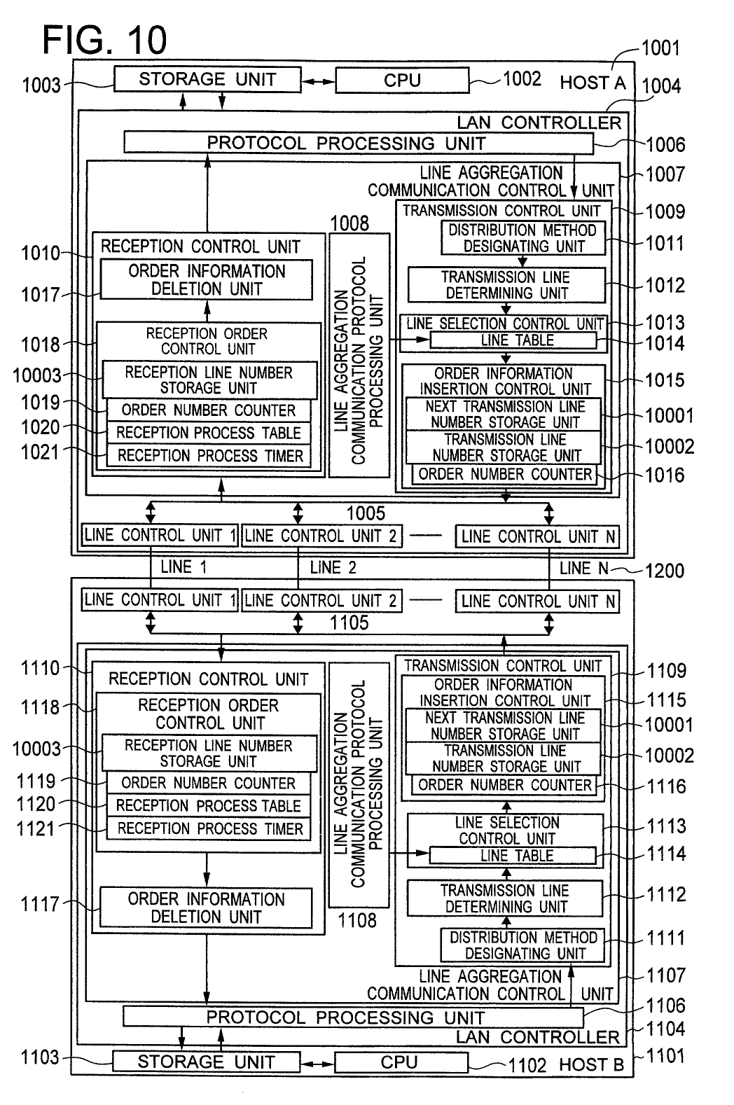

Next, another example of the reception and transmission control units in the hosts of the embodiment will be described. FIG. 10 is a block diagram showing the structure of a data communication system. In the data communication system shown in FIG. 10, identical elements to those shown in the data communication system shown in FIG. 1 are represented by using the same reference numerals as those shown in FIG. 1.

Referring to FIG. 10, similar to the data communication system shown in FIG. 1, a host A 1001 and a host B 1101 are interconnected by a plurality of lines 1 to N 1200. By using these lines, both the hosts communicate with each other. Each of the hosts A 1001 and B 1101 distributes communication frames to the lines 1 to N 1200 for the line aggregation communications in order to use the lines as one logical line. The host A 1001 and host B 1101 have the function of performing the line aggregation communications. Since the communication function of both the hosts is the same, the structure and communication method will be described by taking as an example the host A 1001.

The structure of the host A 1001 shown in FIG. 10 is the same as the structure of the host A 1001 shown in FIG. 1, excepting the transmission control unit 1009 and reception control unit 1010. A transmission line number storage unit 10002 and a next transmission line number storage unit 10001 are newly added to the order information insertion control unit 1015 of the transmission control unit 1009 shown in FIG. 10, and a next reception line number storage unit 10003 is newly added to the reception order control unit 1018 of the reception control unit 1010. Each storage unit will be described when the transmission and reception procedure is described.

In the data communication system shown in FIG. 10, in order to guaranteed the order of frames, the order information to be inserted into the frame is further expanded. The order information to be inserted into a frame includes the order information shown in FIGS. 4 and 9, and new line information representative of the transmission line number of a frame to be transmitted next to the frame inserted with the order information.

When the host A 1001 transmits a first frame, a second frame and a third frame to the host B 1101, the host A 1001 inserts the order information in the first frame, the order information including two information, (1) the order number of the first frame and (2) the number of the line to which the second frame is transmitted. The line number (2) of the line to which the second frame is transmitted is calculated when the first frame is transmitted, in accordance with the frame distribution method. Similarly, when the host A 1001 transmits the second frame, the host A 1001 inserts the order information including (1) the order number of the second frame and (2) the number of the line to which the third frame is transmitted, into the second frame. The order information is inserted in a similar manner when the fourth, fifth, sixth and etc. frames are transmitted.

When the host B 1101 receives, for example, the first frame inserted with the order information, the host B 1101 can identify the line at which the next frame is received, from the line number (2) of the line to which the second frame is transmitted. Therefore, the host B 1101 can perform a reception monitor by concentrating upon only the identified line. Even if the number of lines to be aggregated becomes large, the efficiency of the reception process at the reception side host can be prevented from being lowered.

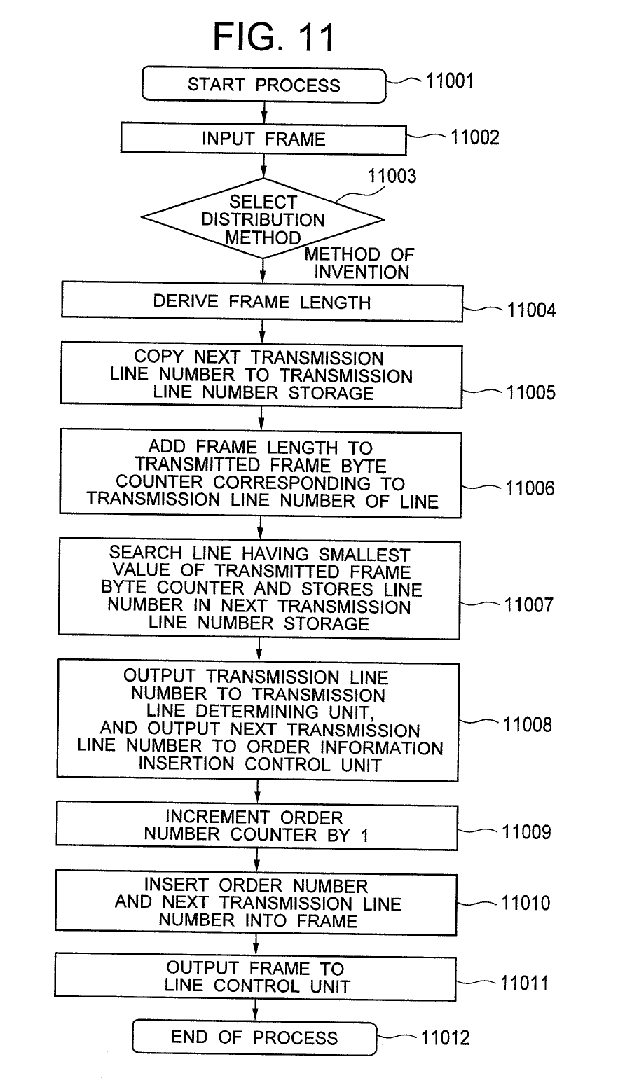

Next, the transmission/reception procedure will be described. First, the transmission procedure when the host A 1001 transmits data to the host B 1101 will be described with reference to FIG. 11.

Similar to the transmission procedure shown in FIG. 5, CPU 1002 executes an application program to generate the data to be transmitted to the host B 1101, and the generated data is stored in some area of the storage unit 1003. The protocol processing unit 1006 receives the transmission data from the storage unit 1003 and converts the data format into the frame format capable of being transmitted to the network. The protocol processing unit 1006 outputs a frame to the transmission control unit 1009 of the line aggregation communication control unit 1007. The transmission control unit 1009 receives the frame supplied from the protocol processing unit 1006 (step 11002). The frame input to the transmission control unit 1009 is input to the transmission line determining unit 1012. The transmission line determining unit 1012 selects the distribution method in accordance with the instruction contents supplied from the distribution method designation unit 1011 (step 11003). The transmission line determining unit 1012 derives the frame length of the transmission frame and outputs the frame length to the line selection control unit 1013 (step 11004). At this time, the line number of the line selected when the previous frame was transmitted is already stored in the transmission line number storage unit 10002 of the order information insertion control unit 1015, and in the next transmission line number storage unit 10001, the line number calculated beforehand when the previous frame was transmitted, i.e., the line number of the line to which the frame currently input to the transmission control unit 1009, is already stored. In order to make this line number stored in the next transmission number storage unit 10001 indicate the line to which the frame currently input in the transmission control unit 1009 is transmitted, the line selection control unit 1013 copies the line number stored in the next transmission line number storage unit 10001 to the transmission line number storage unit 10002 (step 11005). The line selection control unit 1013 adds the frame length (the number of bytes) output from the transmission line determining unit 1012 to the transmitted frame byte counter 2003 corresponding to the entry in which the line number copied to the transmission line number storage unit 10002 is registered among those entries in the line table 1014 to thereby update the line table 1014 (step 11006).

Next, in order to insert the order information into the frame input to the transmission control unit 1009, the line selection control unit 1013 calculates the line number of the line to which the frame to be transmitted next to the input frame. In this case, the line selection control unit 1013 refers to the line table 1014 and compares the transmitted frame byte counters 2003 in respective entries to acquire the line number having the smallest number. The line selection control unit 1013 stores the acquired line number in the next transmission line number storage unit 10001 as the line number of the line to which the next frame is transmitted (step 11007).

The line selection control unit 1013 outputs the line number stored in the transmission line number storage unit 10002 to the transmission line determining unit 1012 as the line number of the line to which the frame is transmitted. The line selection control unit 1013 also outputs the line number stored in the next transmission line number storage unit 10001 to the order information insertion unit 1015 as the order information to be inserted into the frame (step 11008).

The transmission line determining unit 1012 receives the line number output from the line selection control unit 1013 and determines the line to which the frame is transmitted.

After the above processes are completed, the order information insertion control unit 1015 inserts the order information into the frame. This process is executed after the process by the transmission line determining unit 1012. The order information insertion control unit 1015 increments its order number counter 1016 by 1 (step 11009), and inserts the incremented count as the order number and the line number supplied from the line selection control unit 1013 as the line number of the line to which the next frame is transmitted, respectively into the frame (step 11010).

Similar to that shown in FIGS. 4 and 9, the order information to be inserted by the order information insertion control unit 1015 includes the tag ID field indicating that the order information is being inserted and the order number field, and in addition, a line number field storing the line number of the line to which the next frame is transmitted. The order number field may be a field separated from the order number fields 4012 and 9007 shown in FIGS. 4 and 9, or may be a new field added to the order information shown in FIGS. 4 and 9. The format of a frame to which the order information is inserted is similar to that described with reference to FIGS. 4 and 9.

The frame input to the transmission control unit 1009 is output to the line control unit 1005 corresponding to the line 1200 having the line number determined by the transmission line determining unit 1012 (step 11011). The line control unit 1005 received the frame output from the transmission control unit 1009 sends the frame to the corresponding line 1200. If a plurality of frames are to be transmitted, the above-described transmission procedure is repeated.

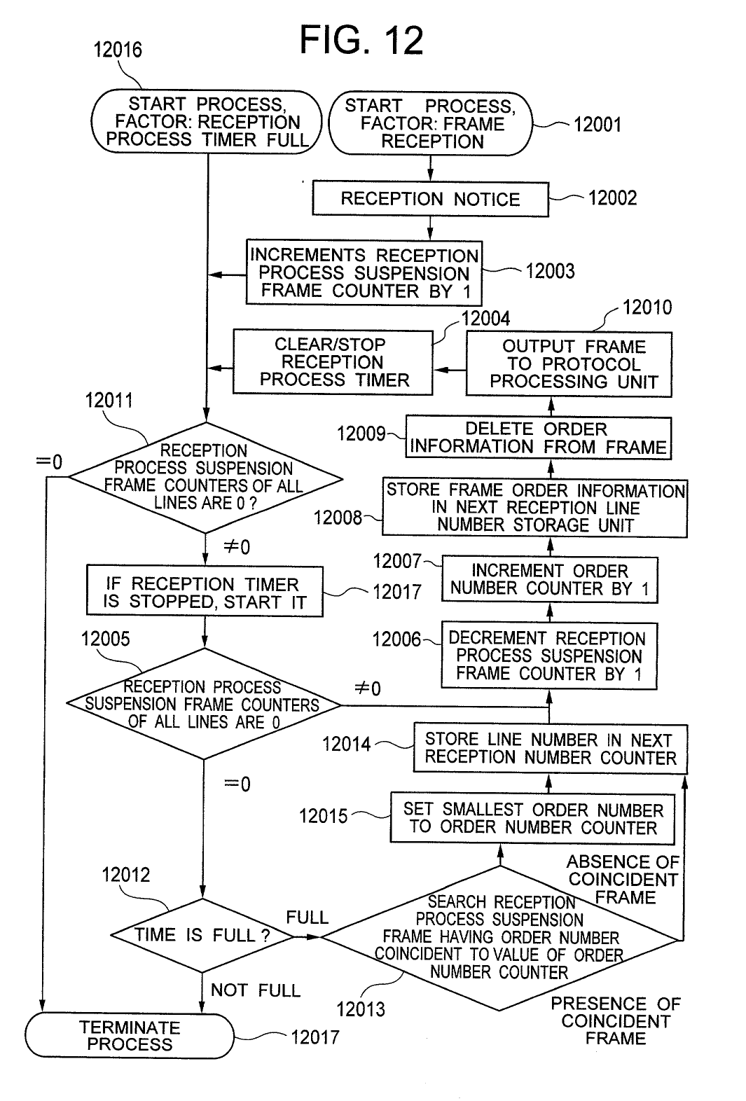

Next, the reception procedure when data transmitted from the host A 1001 is received at the host B 1101 will be described with reference to FIG. 12.

Similar to the reception procedure shown in FIG. 6, a frame transmitted from the host A 1001 is received at one of the line control units 1 to N 1105 of the host B 1101 via a corresponding one of the lines 1 to N 1200. When a frame is received, the process of the host B 1101 starts (step 12001). The line control unit 1 to N 1105 received the frame supplies a reception notice to the reception order control unit 1118 of the reception control unit 1110 (step 12002).

The reception order control unit 1118 received the reception notice does not execute immediately the reception process of the received frame, but selects a frame to be subjected to the reception process in accordance with the order information. First, in order to suspend the reception process for the received frame, of the respective process suspension frame counters 3002 in the reception process table 1120, the reception process suspension frame counter 3002 corresponding to the line number of the line from which the frame was received is incremented by 1 (step 12003). The reception order control unit 1118 refers to the reception process suspension frame counters 3002 so that presence/absence of a reception process suspension frame at each line can be confirmed.

If the reception process suspension frame counters 3002 of all the lines 1 to N are 0 (step 12011), the reception order control unit 1118 terminates the reception process (step 12017). If there is even one reception process suspension frame and the reception process timer 1121 is not operating, then the reception order control unit 1118 starts the reception process timer 1121 (step 12017). The initial value of the reception process timer 1121 is 0 and the value increases with time.

The line number of the line at which the next frame is received, the line number being contained in the order information derived from the previous frame when the reception process was executed for the previous frame, is already stored in the next reception line number storage unit 10103 of the reception order control unit 1118. The reception order control unit 1118 reads the line number stored in the next reception line number storage unit 10103 of the reception process table 1120 and checks whether the value of the reception process suspension frame counter 3002 corresponding to the entry of the reception process table 1120 in which the line number is already registered is 0 or not (step 12005). If the value of the reception process suspension frame counter 3002 is not 0, it is judged that there is a frame to be next subjected to the reception process, and the reception process for the frame starts.

In the reception process, the order number counter 1119 is incremented by 1 (step 12006) and the reception process suspension frame counter 3002 in the reception process table 1120 corresponding to the line via which the frame under the reception process was received is decremented by 1 (step 12007).

Next, the order information contained in the frame under the reception process is derived. By using the line number contained in the order information as a search key, the line number fields 2001 of the host A in the line table 1114 is searched. If an entry having the line number of the host A same as the key line number can be detected, then the line number of the host B corresponding to the detected line number of the host A is read from the line table 1114. The read line number of the host B is stored in the next reception line number storage unit 10103 (step 12008). When the next reception notice is received, by referring to the line number stored in the next reception line number storage unit 10103, the reception order control unit 1118 can identify the line number of the line for which presence/absence of a reception process suspension frame is checked.

Thereafter, the frame is sent to the order information deletion unit 1117 which deletes the unnecessary order information from the frame (step 12009). The reception control unit 1110 outputs the frame with the deleted order information to the protocol processing unit 1106 (step 12010). At this time, the reception order control unit 1118 stops the reception process timer 1121 to clear the value and set the initial value (step 12004). The protocol processing unit 1106 receives the frame output from the reception control unit 1110, converts the frame format into the data format capable of being received by the application program, and passes the frame to the application program.

If at the step 12005 the reception process suspension frame counters are 0, the reception order control unit 1118 checks whether the reception process timer 1112 is full (step 12012). If the reception process timer 1112 is not full, a series of processes are terminated to wait for another reception notice (step 12017).

If at the step 12012 the reception order control unit 1118 judges that the reception process timer 1112 is full, it can be judged that the frame to be next subjected to the reception process was lost. In this case, the reception order control unit 1118 does not wait for the reception of the lost frame, but starts the process for performing the reception process for the next frame. In this case, the reception order control unit 1118 starts the process asynchronously with the frame reception (step 12016).

After the steps 12011, 12017, 12005 and 12012, the reception order control unit 1118 searches the frame inserted with the order information having the order number coincident with the count of the order number counter 1119, among all reception process suspension frames in the lines 1 to N (step 12013). If the frame inserted with the order number coincident with the count can be detected, the reception order control unit 1118 stores the line number of the line at which the frame was received, into the next reception line number storage unit 10103 (step 12014), to thereafter execute the reception process starting from this frame. If there is no frame inserted with the order number coincident with the count, the reception order control unit 1118 searches the frame inserted with the smallest order number from all reception process suspension frames with inserted order numbers. The searched smallest order number is set to the order number counter 1119 (step 12015), and the line number of the line at which the frame inserted with the smallest order number was received, is stored in the next reception storage unit 10103 (step 12014), to thereafter start the reception process starting from this frame. With the above procedure, even if a frame is lost, the reception process by the host B 1101 can be prevented from being stopped because of inconsistency of the order information.

The full time T of the reception process timer 1112 and the processes other than the above processes are similar to those described with FIG. 6.

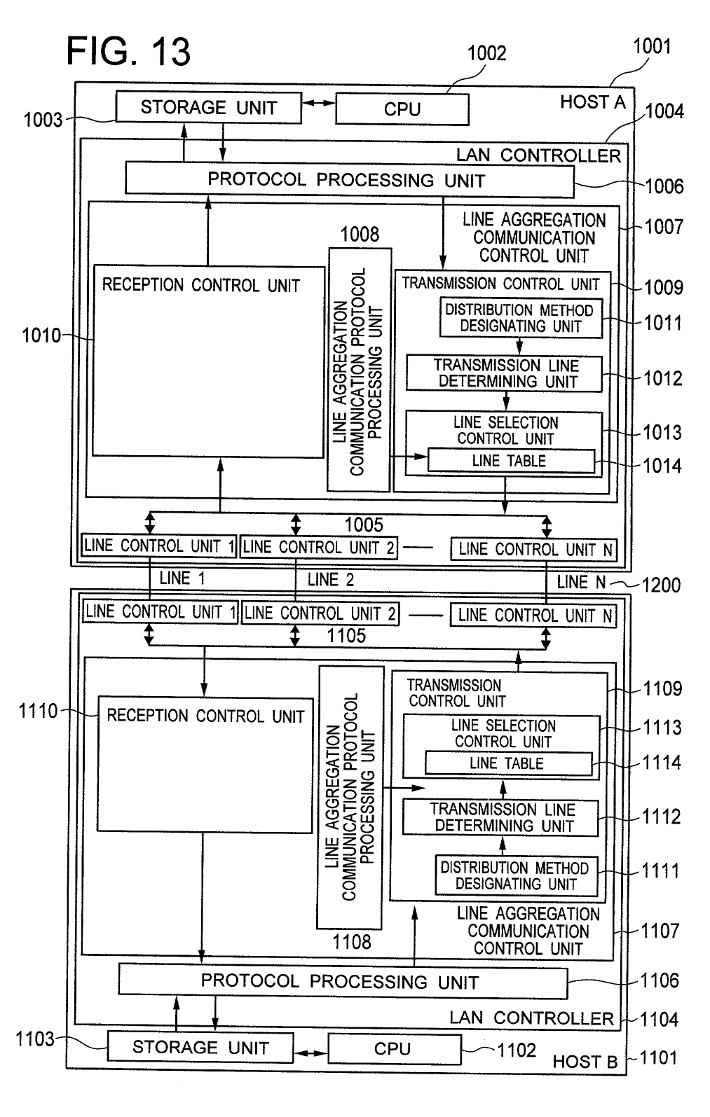

Next, another example of the reception and transmission control units in the hosts of the embodiment will be described. FIG. 13 is a block diagram showing the structure of a data communication system. In the data communication system shown in FIG. 13, identical elements to those shown in the data communication system shown in FIG. 1 are represented by using the same reference numerals as those shown in FIG. 1. Since the function of both the hosts is the same, the structure and communication method will be described by taking as an example the host A 1001.

The structure of the host A 1001 shown in FIG. 130 is the same as the structure of the host A 1001 shown in FIG. 1, excepting the transmission control unit 1009 and reception control unit 1010. The transmission control unit 1010 shown in FIG. 13 is not provided with the order information insertion control unit 1015 shown in FIG. 1, and the reception control unit 1010 shown in FIG. 13 is not provided with the order information deletion unit 1017, reception order control unit 1018, order number counter 1019, reception process table 1020 and reception process timer 1021 shown in FIG. 1. Namely, the transmission control unit 1009 shown in FIG. 13 is not provided with the function of inserting the order information, and the reception control unit 1010 is not provided with the function of deleting the order information and the function of executing the reception process for a frame in accordance with the order information.

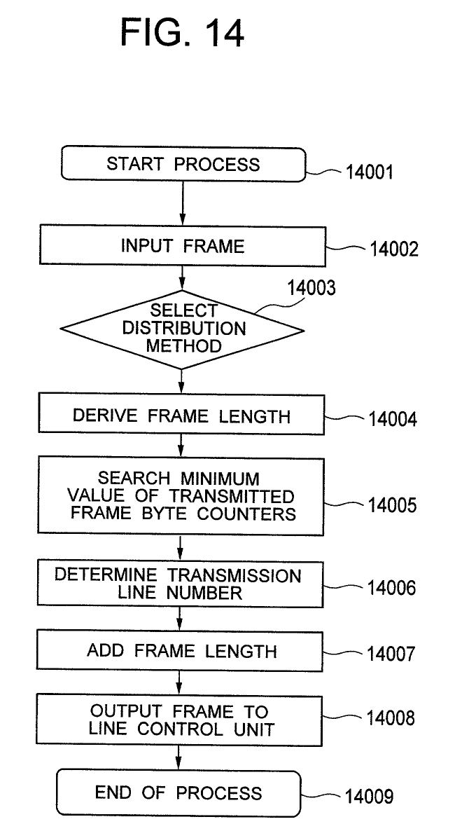

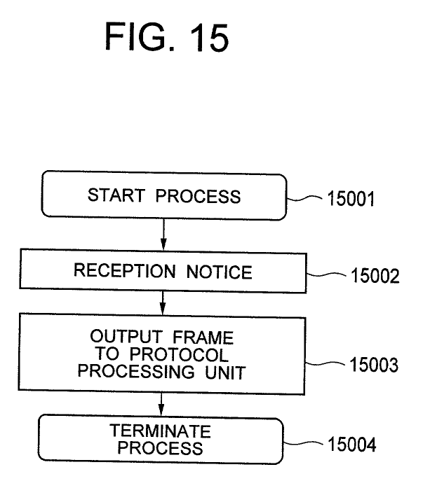

If a communication protocol having a function of correcting the order of received data, such as a TCP (Transmission Control Protocol), is used for communications between the host A 1001 and host B 1101 and if communications use a network which does not cause a large order change unable to be corrected by the order correcting function of the protocol, then line aggregation communications are possible between the hosts having the structure shown in FIG. 13. The transmission procedure by the data communication system shown in FIG. 13 is shown in FIG. 14, and the reception procedure is shown in FIG. 15. As compared with the transmission procedure shown in FIG. 5, the transmission procedure shown in FIG. 14 does not include a series of processes for inserting the order information into a frame. As compared with the reception procedure shown in FIG. 6, the reception procedure shown in FIG. 16 does not include a series of processes for executing the reception process for frames in the correct order. The other processes have been already described with reference to FIGS. 5 and 6.

According to the above-described embodiments, the transmission control unit of the transmission side host selects the line having a minimum cumulative amount of transmitted data and transmits a frame to this line. In this manner, it becomes possible to distribute frames uniformly to each aggregated line and transmit the frames.

The transmission control unit of the transmission side host inserts the order information into a frame, and the reception control unit of the reception side host recognizes the order of a frame from the order information inserted into the received frame, and executes a reception process for frames in accordance with the recognized order. The order of frames at the reception side host can therefore be ensured.

What is claimed is:

1. A data frame distribution method wherein either one of at least two information processing apparatus interconnected by at least two communication lines distributes and transmits a data frame to either one of at least the two communication lines, the method comprising the steps of:
storing an amount of data frames transmitted to at least the two communication lines for each of at least the two communication lines;
generating a data frame to be transmitted;
comparing the stored amounts of data frames with each other;
selecting a communication line having the smallest stored amount of data frames; and
transmitting the generated data frame to the selected communication line.

2. A data frame distribution method according to claim 1, wherein said storing step stores a cumulative value of the number of bytes of data frames transmitted to each of at least the two communication lines, as the amount of data frames.

3. A data frame distribution method according to claim 1, wherein said storing step stores a cumulative value of the number of data frames transmitted to each of at least the two communication lines, as the amount of data frames.

4. A data frame distribution method according to claim 1, wherein said transmitting step further includes a step of adding an amount of the generated data frame to the amount of data frames stored for the selected communication line.

5. A data frame distribution method wherein either one of at least two information processing apparatus interconnected by at least two communication lines distributes and transmits a data frame to either .one of at least the two communication lines, the method comprising the steps of:
storing an amount of data frames transmitted to at least the two communication lines for each of at least the two communication lines;
storing line information of either one of at least the two communication lines;
generating a data frame to be transmitted;
adding an amount of the generated data frame to the amount of data frames stored for the communication line corresponding to the stored line information, and storing an addition result; and
transmitting the generated data frame to the communication line corresponding to the stored line information.

6. A data frame distribution method according to claim 5, wherein said transmitting step further includes the steps of:
comparing the amounts of data frames stored for each of at least the two communication lines with each other;
selecting a communication line having the smallest stored amount of data frames; and
storing line information corresponding to the selected communication line.

7. A data frame distribution method according to claim 5, wherein said step of storing the amount of data frames for each of at least the two communication lines stores a cumulative value of the number of bytes of transmitted data frames, as the amount of data frames.

8. A data frame transmission/reception method wherein between at least two information processing apparatus interconnected by at least two communication lines, a data frame is transmitted/received to/from at least the two communication lines in a distributed manner, the method comprising the steps of:
in a transmission side data processing apparatus, storing an amount of data frames transmitted to at least the two communication lines for each of at least the two communication lines;
generating a data frame to be transmitted;
comparing the stored amounts of data frames with each other;
selecting a communication line having the smallest stored amount of data frames; and
transmitting the generated data frame to the selected communication line, and
in a reception side data processing apparatus,
receiving the data frame transmitted from the transmission side data processing apparatus.

9. A data frame transmission/reception method according to claim 8, further comprising the steps of:
in the transmission side data processing apparatus, counting the number of data frames transmitted at least the two communication lines; and
inserting the counted value in the generated data frame as order information.

10. A data frame transmission/reception method according to claim 9, wherein said inserting step further counts up the counted value and inserts the count-up count in the data frame as the order information.

11. A data frame transmission/reception method according to claim 9, wherein said counting step counts the number of bytes of data frames transmitted to at least the two communication lines.

12. A data frame transmission/reception method according to claim 9, further comprising the steps of:
in the reception side data processing apparatus,
counting the number of data frames received from at least the two communication lines and processed;
comparing the order information inserted into the received data frame with the counted value; and
if the order information is coincident with the counted value, executing processing of the received data frame.

13. A data frame transmission/reception method according to claim 12, wherein if the order information is not coincident with the counted value, said comparing step compares the order information inserted into another data frame received from either one of at least the two communication lines with the counted value.

14. A data frame transmission/reception method according to claim 13, wherein if the order information inserted into all received data frames is not coincident with the counted value, said comparing step suspends processing until another data frame is received from either one of at least the two communication lines.

15. A data frame transmission/reception method according to claim 12, wherein said counting step counts up the counted value after execution of processing the received data frame.

16. A data frame transmission/reception method according to claim 12, wherein said step of executing processing of the received data frame includes a step of deleting the order information inserted into the received data frame.

17. A data frame reception method of receiving a data frame transmitted from either one of at least two information processing apparatus interconnected by at least two communication lines, via either one of at least the two communication lines, the method comprising the steps of:
counting the number of data frames received from either one of at least the two communication lines and processed, and storing the counted value;
receiving a data frame transmitted from either one of at least the two communication lines;
comparing order information inserted into the received data frame with the counted value; and
if the order information is coincident with the counted value, executing processing of the received data frame.

18. A data frame reception method according to claim 17, wherein if the order information is not coincident with the counted value, said comparing step compares the order information inserted into another data frame received from either one of at least the two communication lines with the counted value.

19. A data frame reception method according to claim 17, wherein if the order information inserted into all received data frames is not coincident with the counted value, said comparing step suspends processing until another data frame is received from either one of at least the two communication lines.

20. A data frame reception method according to claim 17, wherein said counting step counts up the counted value after execution of processing the received data frame.

21. A data frame reception method of receiving a data frame transmitted from either one of at least two information processing apparatus interconnected by at least two communication lines, via either one of at least the two communication lines, the method comprising the steps of:
storing line information corresponding to either one of at least the two communication lines, among information inserted into a data frame received from either one of at least the two communication lines and processed;
receiving a data frame from either one of at least the two communication lines;
judging whether the data frame was received from the communication line corresponding to the stored line information; and
if the data frame is received from the communication line corresponding to the stored line information, executing processing of the received data frame.

22. A data frame reception method according to claim 21, wherein if the data frame was not received from the communication line corresponding to the stored line information, said judging step suspends processing until a data frame is received from the communication line corresponding to the stored line information.

23. A data frame reception method according to claim 21, wherein said step of executing processing of the receiving data frame stored line information inserted into the received data frame.
